(19) United States
(12) Patent Application Publication
(10) Pub. No.: US 2026/0070360 A1
(43) Pub. Date: Mar. 12, 2026

(54) THERMAL PRINTER

(71) Applicant: ZHONGSHAN POLONO ELECTRONIC TECHNOLOGY CO., LTD., Zhongshan (CN)

(72) Inventors: Wenyi FAN, Zhongshan (CN); Dongming LIN, Zhongshan (CN)

(73) Assignee: ZHONGSHAN POLONO ELECTRONIC TECHNOLOGY CO., LTD., Zhongshan (CN)

(21) Appl. No.: 19/392,010

(22) Filed: Nov. 17, 2025

Related U.S. Application Data
(63) Continuation of application No. PCT/CN2024/094093, filed on May 18, 2025.

(30) Foreign Application Priority Data
May 18, 2023 (CN) 202321212008.5
Jan. 5, 2024 (CN) 202420025292.3

(51) Int. Cl. B41J 29/13; B41J 2/315; B41J 3/407; B41J 15/04; B41J 29/02

(52) U.S. Cl. CPC B41J 29/13; B41J 2/315; B41J 3/4075; B41J 15/042; B41J 29/02

(57) ABSTRACT

A thermal printer includes a top cover assembly and a main assembly coupled to each other. The main assembly includes a housing and a paper compartment for holding an imaging medium. The top cover assembly and the main assembly are coupled via a connecting portion, wherein the connecting portion is configured to allow the top cover assembly to be flipped relative to the main assembly. The connecting portion includes a connecting assembly provided on the top cover assembly and a cooperating assembly provided on the main assembly. One of the connecting assembly and the cooperating assembly includes a hole or a slot, and the other of the connecting assembly and the cooperating assembly includes a protrusion, a pin, or a positioning post for insertion into the hole or the slot. The thermal printer has the advantages of a simple installation structure and a reliable connection for the top cover assembly.

### CROSS-REFERENCE TO RELATED APPLICATIONS

This application is a continuation application of International Application No. PCT/CN2024/094093, filed on May 18, 2024, which claims priority to Chinese Patent Application No. 202321212008.5, filed on May 18, 2023, and Chinese Patent Application No. 202420025292.3, filed on Jan. 5, 2024. All of the aforementioned applications are incorporated herein by reference in their entireties.

### TECHNICAL FIELD

The present disclosure relates to the field of printing, and in particular, to a thermal printer.

### BACKGROUND

Thermal printers are widely used in scenarios such as warehousing, logistics, and cashier services. They generally use a thermal method to form images or text on thermal paper, after which the imaged paper is ejected. A thermal printer usually includes a main assembly and a top cover assembly that are coupled to each other. In the prior art, the top cover assembly and the main assembly are connected by a hinge shaft that is independent of the top cover assembly and the main assembly. This hinge shaft passes through connection holes in the top cover assembly and the main assembly. With this connection structure, the hinge shaft is prone to falling out, which compromises a stable connection between the top cover assembly and the main assembly.

### SUMMARY

In view of the technical problem described above, the present disclosure provides a thermal printer that facilitates a stable connection between a top cover assembly and a main assembly.

The thermal printer provided by the present disclosure includes a top cover assembly and a main assembly coupled to each other. The main assembly includes a housing and a paper compartment for holding an imaging medium. The top cover assembly and the main assembly are coupled via a connecting portion, and the connecting portion is configured to allow the top cover assembly to be flipped relative to the main assembly. The connecting portion includes a connecting assembly provided on the top cover assembly and a cooperating assembly provided on the main assembly. One of the connecting assembly and the cooperating assembly includes a hole or a slot, and the other of the connecting assembly and the cooperating assembly includes a protrusion, a pin, or a positioning post configured for insertion into the hole or the slot.

Optionally, the connecting assembly is integrally formed with the top cover assembly, and the cooperating assembly is integrally formed with at least one of the housing and the paper compartment.

In some embodiments of the present disclosure, the cooperating assembly includes a paper compartment mounting portion and an avoidance groove. The paper compartment mounting portion includes a first mounting portion body, a second mounting portion body, a first mounting portion, and a second mounting portion. The first mounting portion and the second mounting portion are respectively provided on the first mounting portion body and the second mounting portion body and are oppositely arranged in a left-right direction. The avoidance groove is located between the first mounting portion and the second mounting portion.

Further, the connecting assembly includes a first connecting body, a second connecting body, a first connecting end, a second connecting end, and a notch portion. The first connecting end and the second connecting end are respectively provided on the first connecting body and the second connecting body and are oppositely arranged in the left-right direction. The notch portion is located between the first connecting body and the second connecting body.

Further, one of the first connecting end and the first mounting portion is configured as an opening or a mounting groove serving as the hole or the slot, and the other of the first connecting end and the first mounting portion is configured as the protrusion. One of the second connecting end and the second mounting portion is configured as an opening or a mounting groove serving as the hole or the slot, and the other of the second connecting end and the second mounting portion is configured as the protrusion. The protrusion enters the opening or the mounting groove.

Optionally, the connecting assembly is connected to the housing and the paper compartment.

In some embodiments of the present disclosure, the cooperating assembly also includes a paper compartment mounting portion and a housing mounting portion. The paper compartment mounting portion includes a first mounting portion and a second mounting portion oppositely arranged in a left-right direction. The housing mounting portion includes a third mounting portion and a fourth mounting portion oppositely arranged in the left-right direction.

Further, the connecting assembly includes a first connecting body, a second connecting body, a first connecting end, a second connecting end, and a notch portion. The first connecting end and the second connecting end are respectively provided on the first connecting body and the second connecting body and are oppositely arranged in the left-right direction. The notch portion is located between the first connecting body and the second connecting body.

Further, the first connecting end cooperates with the first mounting portion and the third mounting portion, and the second connecting end cooperates with the second mounting portion and the fourth mounting portion.

Further, the first mounting portion and the second mounting portion are configured as an opening or an open groove, where the open groove is formed in an up-down direction and has an upward opening. One of the third mounting portion and the first connecting end is configured as the protrusion, and the other is configured as the hole or the slot such as a through-hole or a cooperating groove. One of the fourth mounting portion and the second connecting end is configured as the protrusion, and the other is configured as the hole or the slot such as a through-hole or a cooperating groove. The protrusion passes through the first mounting portion or the second mounting portion and enters the hole or the slot.

Further, the housing includes a first housing and a second housing coupled to each other in the left-right direction. The third mounting portion is provided on the first housing, and the fourth mounting portion is provided on the second housing.

Further, the paper compartment includes a side wall provided on the same side as the connecting portion, and the paper compartment mounting portion is provided on the side wall.

In some embodiments of the present disclosure, the connecting assembly includes a connecting assembly body, and a penetrating hole serving as the hole is provided on the connecting assembly body.

Further, the penetrating hole penetrates the connecting assembly body in the left-right direction.

Further, the cooperating assembly includes a paper compartment mounting portion. The paper compartment mounting portion includes a first mounting portion body, a second mounting portion body, a first mounting portion, and a second mounting portion. The first mounting portion and the second mounting portion are respectively provided on the first mounting portion body and the second mounting portion body and are oppositely arranged in the left-right direction.

Further, the cooperating assembly also includes a housing mounting portion. The housing mounting portion includes a third mounting portion and a fourth mounting portion oppositely arranged in the left-right direction.

Further, one of the third mounting portion and the fourth mounting portion is configured as the positioning post, and the other is configured as another hole or slot such as a through-hole or a cooperating groove. The positioning post passes through the first mounting portion, the penetrating hole, and the second mounting portion and enters the other hole or slot.

Further, the first mounting portion and the second mounting portion are configured as an opening or an open groove, where the open groove is formed in an up-down direction and has an upward opening. The positioning post passes through the first mounting portion, the penetrating hole, and the second mounting portion and enters the through-hole or the cooperating groove.

Further, the paper compartment includes a side wall provided on the same side as the connecting portion, and the paper compartment mounting portion is provided on the side wall. The housing includes a first housing and a second housing coupled to each other in the left-right direction. The third mounting portion is provided on the first housing, and the fourth mounting portion is provided on the second housing. The penetrating hole is configured to cooperate with the third mounting portion or the fourth mounting portion.

Further, an avoidance groove is formed between the first mounting portion and the second mounting portion, and the connecting assembly body is disposed in the avoidance groove.

Further, when the third mounting portion or the fourth mounting portion is configured as another hole or slot such as a through-hole or a cooperating groove, the housing at the location of the third mounting portion or the fourth mounting portion is provided with a protection portion, and the protection portion extends from the housing toward the rear side of the thermal printer.

In some embodiments of the present disclosure, one of the connecting assembly and the cooperating assembly is provided with a connection seat, and the connection seat is respectively provided with the pin on opposite sides in a direction of a rotation axis of the top cover assembly. The other of the connecting assembly and the cooperating assembly is provided with a recessed portion for receiving the connection seat. Two opposite side walls of the recessed portion in the direction of the rotation axis are both provided with a connection hole serving as the hole or the slot. The pin is rotatably engaged with the connection hole.

Further, two opposite side walls of the recessed portion in the direction of the rotation axis are both provided with a guide groove, and the guide groove is configured to guide the pin into the connection hole. The connection hole is spaced apart from the guide groove, and the guide groove has a pin export end close to the connection hole.

Further, the pin export end and/or a distal end of the pin is provided with a guide surface inclined with respect to the rotation axis, thereby permitting the pin to exit from the guide groove.

Optionally, the pin and the connection seat are fixedly connected or have an integrally formed structure.

Optionally, the pin is configured to be movable relative to the connection seat along the rotation axis. An elastic member connected to the pin is provided in the connection seat, thereby permitting the pin to extend and retract along the rotation axis.

Further, the connection seat is provided at one end of the top cover assembly. A side of the top cover assembly facing the main assembly is provided with a cover base plate, and the connection seat is fixedly connected to the cover base plate or has an integrally formed structure therewith.

Further, the connection seat is provided at one end of the top cover assembly. A side of the top cover assembly facing the main assembly is provided with a cover base plate. The connection seat is provided with a mounting portion, and the mounting portion and the cover base plate form a snap-fit engagement. The pin and the mounting portion form a shaft-hole engagement. The elastic member is provided in a receiving groove of the mounting portion.

Further, a surface of the pin is provided with a limiting protrusion, and the limiting protrusion is provided in the connection seat to prevent the pin from detaching from the connection seat.

Further, the elastic member is a spring.

Optionally, the pin comprises an elastic portion made of an elastic material, thereby permitting the pin to extend and retract along the rotation axis.

Further, the thermal printer is a label printer.

In some embodiments of the present disclosure, the connecting assembly includes an avoidance groove and a top cover connecting portion. The top cover connecting portion includes a first connecting body, a second connecting body, a first connecting portion, and a second connecting portion. The first connecting portion and the second connecting portion are respectively provided on the first connecting body and the second connecting body and are oppositely arranged in the left-right direction. The avoidance groove is located between the first connecting portion and the second connecting portion.

Further, the cooperating assembly includes a first mounting portion body, a second mounting portion body, a first mounting end, a second mounting end, and a protrusion portion. The first mounting end and the second mounting end are respectively provided on the first mounting portion body and the second mounting portion body and are oppositely arranged in the left-right direction. The protrusion portion is located between the first mounting portion body and the second mounting portion body.

Further, one of the first connecting portion and the first mounting end is configured as an opening or a mounting groove serving as the hole or the slot, and the other of the first connecting portion and the first mounting end is configured as the protrusion. One of the second connecting portion and the second mounting end is configured as an opening or a mounting groove serving as the hole or the slot, and the other of the second connecting portion and the second mounting end is configured as the protrusion, wherein the protrusion enters the opening or the mounting groove. Or, the first connecting portion, the first mounting end, the second connecting portion, and the second mounting end are penetratingly connected by a positioning post. Or, the first connecting portion and the first mounting end are connected by a first pin, and the second connecting portion and the second mounting end are connected by a second pin.

For a clearer explanation of the objectives, technical solutions, and advantages of the present disclosure, the present disclosure will be further described in detail below with reference to the accompanying drawings and specific embodiments.

### BRIEF DESCRIPTION OF THE DRAWINGS

FIG. 1 is a perspective view of a thermal printer according to a first set of embodiments of the present disclosure.

FIG. 2 is a perspective view of partial components of the thermal printer according to the first set of embodiments of the present disclosure.

FIG. 3 is a perspective view of the thermal printer with a first housing hidden according to the first set of embodiments of the present disclosure.

FIG. 4 is a perspective view of the thermal printer with a grip portion hidden according to the first set of embodiments of the present disclosure.

FIG. 5A is a perspective view of a top cover assembly according to Embodiment 1 of the present disclosure.

FIG. 5B is a perspective view of a paper compartment according to Embodiment 1 of the present disclosure.

FIG. 6A is a perspective view of a paper compartment according to Embodiment 2 of the present disclosure.

FIG. 6B is a schematic view of a second housing according to Embodiment 2 of the present disclosure.

FIG. 7A is a perspective view of a top cover assembly according to Embodiment 3 of the present disclosure.

FIG. 7B is an exploded view of a second housing and a first housing of the thermal printer with some components hidden according to Embodiment 3 of the present disclosure.

FIG. 8 is an exploded structural view of a label printer according to Embodiment 4 of the present disclosure.

FIG. 9 is a partial structural view of a main body of the label printer according to Embodiment 4 of the present disclosure.

FIG. 10 is a structural view of a cover assembly of the label printer according to Embodiment 4 of the present disclosure.

FIG. 11 is a partial structural view of the cover assembly of the label printer according to Embodiment 4 of the present disclosure.

FIG. 12 is a partial structural view of a cover assembly of a label printer according to Embodiment 5 of the present disclosure.

FIG. 13 is a partial exploded structural view of the cover assembly of the label printer according to Embodiment 5 of the present disclosure.

FIG. 14 is a partial structural view of a cover assembly of a label printer according to Embodiment 6 of the present disclosure.

FIG. 15 is a partial exploded structural view of the cover assembly of the label printer according to Embodiment 6 of the present disclosure.

### DETAILED DESCRIPTION OF THE EMBODIMENTS

### First Set of Embodiments (Embodiment 1-Embodiment 3 and Variations Thereof)

A first set of embodiments of the present disclosure provides a thermal printer, comprising a top cover assembly 20 and a main assembly 10 coupled to each other. The main assembly 10 includes a housing 11 and a paper compartment 30 for holding an imaging medium. The top cover assembly 20 and the main assembly 10 are coupled via a connecting portion 102. The connecting portion 102 includes a connecting assembly 103 and a cooperating assembly 104. The connecting assembly 103 is integrally formed with the top cover assembly 20, and the cooperating assembly 104 is integrally formed with at least one of the housing 11 and the paper compartment 30.

The paper compartment 30 includes a side wall 31 provided on the same side as the connecting portion 102. The cooperating assembly 104 includes a paper compartment mounting portion and an avoidance groove 1c4 provided on the side wall 31. The paper compartment mounting portion includes a first mounting portion body 1a4, a second mounting portion body 1b4, a first mounting portion, and a second mounting portion. The first mounting portion and the second mounting portion are respectively provided on the first mounting portion body 1a4 and the second mounting portion body 1b4 and are oppositely arranged in a left-right direction. The avoidance groove 1c4 is located between the first mounting portion and the second mounting portion.

Further, the connecting assembly 103 includes a first connecting body 1a3, a second connecting body 1b3, a first connecting end, a second connecting end, and a notch portion 1c3. The first connecting end and the second connecting end are respectively provided on the first connecting body 1a3 and the second connecting body 1b3 and are oppositely arranged in the left-right direction. The notch portion 1c3 is located between the first connecting body 1a3 and the second connecting body 1b3. The first connecting end cooperates with the first mounting portion, and the second connecting end cooperates with the second mounting portion.

In some embodiments, one of the first connecting end and the first mounting portion is configured as an opening or a mounting groove, and the other is configured as a protrusion. One of the second connecting end and the second mounting portion is configured as an opening or a mounting groove, and the other is configured as a protrusion. The protrusion enters the opening or the mounting groove.

In some other embodiments, the housing 11 includes a first housing 11a and a second housing 11b coupled to each other in the left-right direction. The cooperating assembly 104 further includes a housing mounting portion. The housing mounting portion includes a third mounting portion and a fourth mounting portion oppositely arranged in the left-right direction. The third mounting portion is provided on the first housing 11a, and the fourth mounting portion is provided on the second housing 11b. The first connecting end cooperates with the first mounting portion and the third mounting portion, and the second connecting end cooperates with the second mounting portion and the fourth mounting portion.

Further, the first mounting portion and the second mounting portion are each configured as an opening or an open groove. The open groove is formed in an up-down direction and has an upward opening. One of the third mounting portion and the first connecting end is configured as a protrusion, and the other is configured as a through-hole or a cooperating groove. One of the fourth mounting portion and the second connecting end is configured as a protrusion, and the other is configured as a through-hole or a cooperating groove. The protrusion passes through the first mounting portion or the second mounting portion and enters the through-hole or the cooperating groove.

In some other embodiments, the connecting assembly 103 includes a connecting assembly body 1d3 and a penetrating hole 1e3 provided on the connecting assembly body 1d3. In the left-right direction, the penetrating hole 1e3 penetrates the connecting assembly body 1d3. The housing 11 includes a first housing 11a and a second housing 11b coupled to each other in the left-right direction. The cooperating assembly 104 further includes a housing mounting portion. The housing mounting portion includes a third mounting portion and a fourth mounting portion oppositely arranged in the left-right direction. The third mounting portion is provided on the first housing 11a, and the fourth mounting portion is provided on the second housing 11b. The penetrating hole 1e3 is configured to cooperate with the third mounting portion or the fourth mounting portion.

Further, one of the first mounting portion and the second mounting portion is configured as an opening or an open groove, and the other is also configured as an opening or an open groove. The open groove is formed in an up-down direction and has an upward opening. One of the third mounting portion and the fourth mounting portion is configured as a positioning post, and the other is configured as a through-hole or a cooperating groove. The positioning post passes through the first mounting portion, the penetrating hole, and the second mounting portion and enters the through-hole or the cooperating groove.

Further, when the third mounting portion or the fourth mounting portion is configured as a through-hole or a cooperating groove, the housing 11 at the location of the third mounting portion or the fourth mounting portion is provided with a protection portion 1e42. The protection portion 1e42 extends from the housing 11 toward the rear side of the thermal printer.

Hereinafter, the structure of the thermal printer of the first set of embodiments will be specifically described with reference to the accompanying drawings.

### Overall Structure of the Thermal Printer

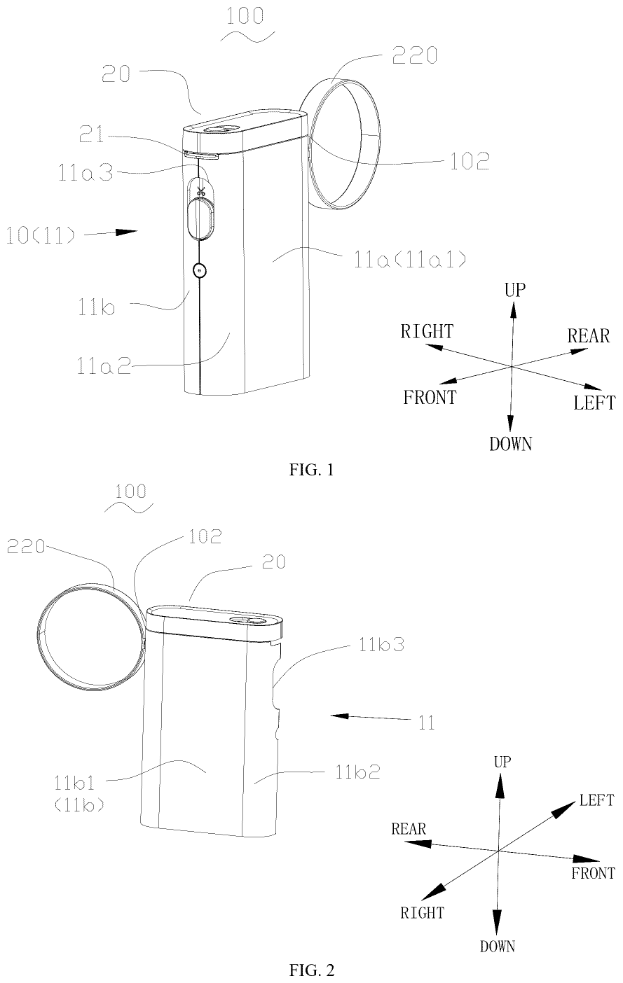

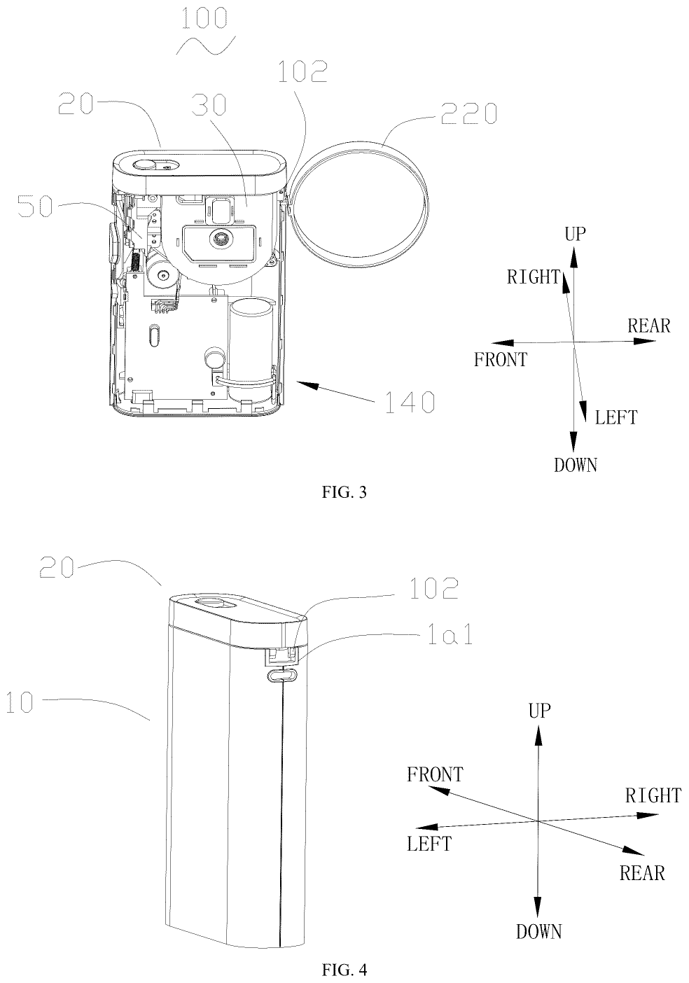

FIG. 1 is a perspective view of a thermal printer according to a first set of embodiments of the present disclosure; FIG. 2 is a perspective view of partial components of the thermal printer according to the first set of embodiments of the present disclosure; FIG. 3 is a perspective view of the thermal printer with a first housing hidden according to the first set of embodiments of the present disclosure; FIG. 4 is a perspective view of the thermal printer with a grip portion hidden according to the first set of embodiments of the present disclosure.

As shown in FIG. 1, from an overall perspective, the thermal printer 100 according to the first set of embodiments of the present disclosure includes a main assembly 10 and a top cover assembly 20 coupled to each other. A grip portion 220 is connected to either the main assembly 10 or the top cover assembly 20, so that a user can easily pick up the thermal printer 100. The top cover assembly 20 is configured to be coupled to the main assembly 10 and can be flipped relative to the main assembly 10. The location where the main assembly 10 and the top cover assembly 20 are coupled to each other is called a connecting portion 102. The main assembly 10 and the top cover assembly 20 may be connected by mechanical locking means or by magnetic locking means. When a mechanical lock is used, the top cover assembly 20 is also provided with an unlocking device, and the user can operate the unlocking device to release the lock between the main assembly 10 and the top cover assembly 20.

For ease of description, the thermal printer 100 is first defined as follows. As shown in FIG. 1, when the thermal printer 100 is in a normal placement state, the height direction of the thermal printer 100 is the up-down direction, and the width direction is the left-right direction. The up-down direction and the left-right direction intersect. Preferably, the up-down direction and the left-right direction are perpendicular to each other. The direction that intersects both the up-down direction and the left-right direction is the front-rear direction. Preferably, the front-rear direction is perpendicular to both the up-down direction and the left-right direction. The side where the main assembly 10 and the top cover assembly 20 are connected is the rear side, and the side opposite to the rear side is the front side.

As shown in FIG. 1 and FIG. 3, the main assembly 10 includes a housing 11, a paper compartment 30, a paper cutting mechanism 50, a paper exit 21, and an electronic assembly 140. When the thermal printer 100 is working, a roll of imaging medium is installed in the paper compartment 30, the paper cutting mechanism 50 is configured to cut the imaging medium supplied to the paper exit 21, and the paper exit 21 is located on a side opposite to the side where the connecting portion 102 is located. At least a part of the paper compartment 30, at least a part of the paper cutting mechanism 50, and at least a part of the electronic assembly 140 are all located in a cavity enclosed by the housing 11. Preferably, the housing 11 includes a first housing 11a and a second housing 11b coupled in the left-right direction (as shown in FIG. 1), located on the left and right sides of the paper compartment 30, respectively. The cavity is located between the first housing 11a and the second housing 11b. The paper exit 21 is also located between the first housing 11a and the second housing 11b.

The first housing 11a includes a main housing 11a1 extending along the up-down direction and the front-rear direction, and an extension housing 11a2 connected to the main housing 11a1. A notch 11a3 is at least partially formed on the extension housing 11a2. The second housing 11b has a structure substantially the same as the first housing 11a, and also includes a main housing 11b1 extending along the up-down direction and the front-rear direction, and an extension housing 11b2 connected to the main housing 11b1. A notch 11b3 is at least partially formed on the extension housing 11b2. When the first housing 11a and the second housing 11b are coupled, the notch 11a3 and the notch 11b3 are opposite in the left-right direction. The paper cutting mechanism 50 is installed in the cavity enclosed by the housing 11, and a part of the paper cutting mechanism 50 is exposed from the notch 11a3/11b3. As shown in FIG. 4, the housing 11 is provided with an exposure opening 1a1 on a side opposite to the side where the paper exit 21 is located. The connecting portion 102 is exposed from the exposure opening 1a1.

### Embodiment 1

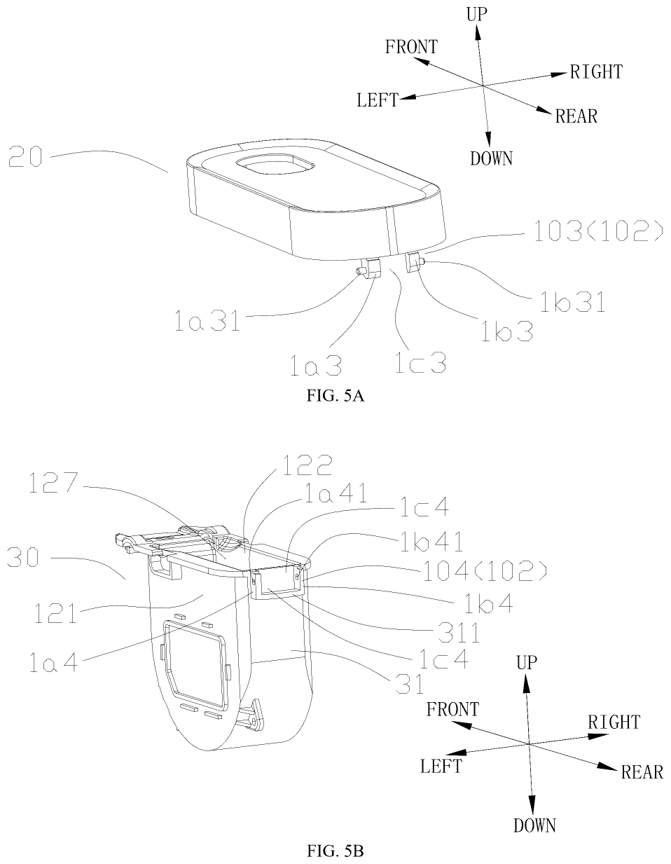

FIG. 5A is a perspective view of a top cover assembly according to Embodiment 1 of the present disclosure; FIG. 5B is a perspective view of a paper compartment according to Embodiment 1 of the present disclosure.

As shown in FIG. 5A and FIG. 5B, the connecting portion 102 includes a connecting assembly 103 provided on the top cover assembly 20 and a cooperating assembly 104 provided on the main assembly 10. At least a part of the connecting assembly 103 cooperates with the cooperating assembly 104, so that the top cover assembly 20 and the main assembly 10 are coupled to each other.

The connecting assembly 103 includes a first connecting body 1a3, a second connecting body 1b3, a first connecting end, a second connecting end, and a notch portion 1c3. The top cover assembly 20 also includes a bottom wall (not shown in the figure) facing the main assembly 10. The first connecting body 1a3 and the second connecting body 1b3 extend downward from the bottom wall. The first connecting end is provided on the first connecting body 1a3, and the second connecting end is provided on the second connecting body 1b3. The first connecting body 1a3 and the second connecting body 1b3 are spaced apart and oppositely arranged in the left-right direction, respectively located on the left and right sides of the notch portion 1c3. The provision of the notch portion 1c3 facilitates deformation when the connecting assembly 103 cooperates with the cooperating assembly 104, thereby making it convenient to install the top cover assembly 20 onto the main assembly 10, and also saving raw materials.

Specifically, the first connecting end is configured as a first protrusion 1a31, and the first protrusion 1a31 extends leftward from the first connecting body 1a3. The second connecting end is configured as a second protrusion 1b31, and the second protrusion 1b31 extends rightward from the second connecting body 1b3. In other embodiments, the first protrusion 1a31 may also extend rightward from the first connecting body 1a3, and the second protrusion 1b31 may extend leftward from the second connecting body 1b3.

The connecting assembly 103 and the top cover assembly 20 are integrally formed. This design can reduce the number of parts of the top cover assembly 20, prevent the connection between the top cover assembly 20 and the main assembly 10 from being unstable due to engagement clearance between parts, and also reduce assembly steps, thereby improving assembly efficiency.

The paper compartment 30 includes a left wall 121 and a right wall 122 that are spaced apart and oppositely arranged in the left-right direction. A paper compartment interior 127 is formed between the left wall 121 and the right wall 122. The paper compartment 30 also includes a side wall 31 provided on the same side as the connecting portion 102. The side wall 31 extends in the up-down direction and the left-right direction. The cooperating assembly 104 includes a paper compartment mounting portion and an avoidance groove 1c4 provided on the side wall 31. The paper compartment mounting portion includes a first mounting portion body 1a4, a second mounting portion body 1b4, a first mounting portion, and a second mounting portion. The first mounting portion and the second mounting portion are respectively provided on the first mounting portion body 1a4 and the second mounting portion body 1b4 and are spaced apart and oppositely arranged in the left-right direction. The first mounting portion is a first opening 1a41 provided on the left side of the avoidance groove 1c4, and the second mounting portion is a second opening 1b41 provided on the right side of the avoidance groove 1c4. The first opening 1a41 penetrates the first mounting portion body 1a4 in the left-right direction, and the second opening 1b41 penetrates the second mounting portion body 1b4 in the left-right direction. The first protrusion 1a31 can enter the first opening 1a41, and the second protrusion 1b31 can enter the second opening 1b41. In other embodiments, the first mounting portion and the second mounting portion may also be configured as mounting grooves, as long as the first protrusion 1a31 can enter the first mounting portion and the second protrusion 1b31 can enter the second mounting portion.

The side wall 31 of the paper compartment 30 also includes a protruding rib 311 extending rearward in the front-rear direction. The protruding rib 311 is located below the first mounting portion and the second mounting portion. The avoidance groove 1c4 is enclosed by the first mounting portion body 1a4, the second mounting portion body 1b4, and the protruding rib 311, and is located between the first mounting portion body 1a4 and the second mounting portion body 1b4. When the connecting assembly 103 cooperates with the cooperating assembly 104, at least a part of the notch portion 1c3 enters the avoidance groove 1c4. The first connecting end and the second connecting end may be connected with the first mounting portion and the second mounting portion respectively from inside the avoidance groove 1c4, or the first connecting end and the second connecting end may be connected with the first mounting portion and the second mounting portion respectively from outside the avoidance groove 1c4.

In other embodiments, the first connecting end and the second connecting end of the connecting assembly 103 are configured as an opening or a mounting groove. The first mounting portion and the second mounting portion of the cooperating assembly 104 are configured as a protrusion. The protrusion can enter the opening or the mounting groove, thereby connecting the connecting assembly 103 with the cooperating assembly 104. Alternatively, one of the first connecting end and the second connecting end of the connecting assembly 103 is configured as an opening or a mounting groove, and the other is configured as a protrusion. Correspondingly, one of the first mounting portion and the second mounting portion of the cooperating assembly 104 is configured as a protrusion, and the other is configured as an opening or a mounting groove. The protrusion can enter the opening or the mounting groove, thereby connecting the connecting assembly 103 with the cooperating assembly 104.

In some other variations of Embodiment 1, the connecting assembly may be configured to include an avoidance groove and a top cover connecting portion. The top cover connecting portion includes a first connecting body, a second connecting body, a first connecting portion, and a second connecting portion. The first connecting portion and the second connecting portion are respectively provided on the first connecting body and the second connecting body and are oppositely arranged in the left-right direction. The avoidance groove is located between the first connecting portion and the second connecting portion. The cooperating assembly includes a first mounting portion body, a second mounting portion body, a first mounting end, a second mounting end, and a protrusion portion. The first mounting end and the second mounting end are respectively provided on the first mounting portion body and the second mounting portion body and are oppositely arranged in the left-right direction. The protrusion portion is located between the first mounting portion body and the second mounting portion body. The avoidance groove located between the first connecting portion and the second connecting portion forms a mounting/avoidance space for the protrusion portion.

Among them, one of the first connecting portion and the first mounting end is configured as an opening or a mounting groove, and the other of the first connecting portion and the first mounting end is configured as a protrusion. One of the second connecting portion and the second mounting end is configured as an opening or a mounting groove, and the other of the second connecting portion and the second mounting end is configured as a protrusion. The protrusion enters the opening or mounting groove and forms a rotational engagement, so that the top cover assembly can be flipped relative to the main assembly. Or, the first connecting portion, the first mounting end, the second connecting portion, and the second mounting end are penetratingly connected by a positioning post, so that the top cover assembly can be rotated about the positioning post relative to the main assembly. Or, the first connecting portion and the first mounting end are connected by a first pin, and the second connecting portion and the second mounting end are connected by a second pin, so that the top cover assembly can be rotated about the first pin and the second pin relative to the main assembly.

### Embodiment 2

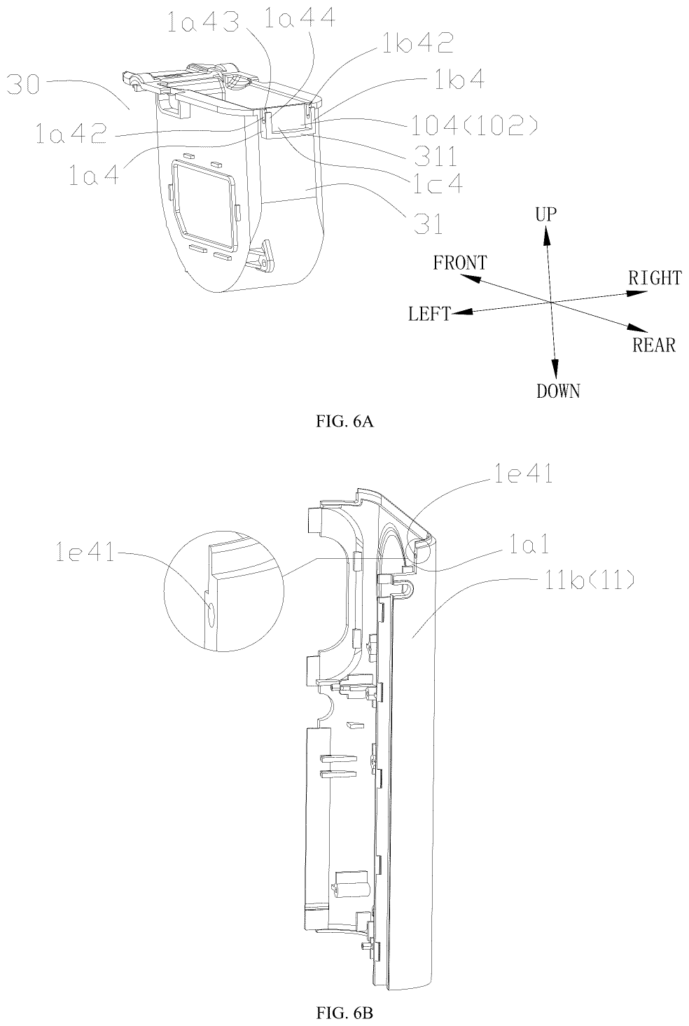

FIG. 6A is a perspective view of a paper compartment according to Embodiment 2 of the present disclosure; FIG. 6B is a schematic view of a second housing according to Embodiment 2 of the present disclosure.

As shown in FIG. 6A and FIG. 6B, the connecting assembly 103 involved in this embodiment is substantially the same as in Embodiment 1, and will not be repeated here. The cooperating assembly 104 involved in this embodiment is partially the same and partially different from that in Embodiment 1. The differences will be described in this embodiment, and the similarities will not be repeated.

In this embodiment, the first mounting portion body 1a4 and the first mounting portion form a first mounting guide rail, and the second mounting portion body 1b4 and the second mounting portion form a second mounting guide rail. The first mounting portion body 1a4 includes a first mounting body front portion 1a43 and a first mounting body rear portion 1a44 provided in the front-rear direction. The first mounting portion is a first open groove 1a42 formed in the up-down direction with an upward opening. The first open groove 1a42 is located between the first mounting body front portion 1a43 and the first mounting body rear portion 1a44. When the connecting assembly 103 cooperates with the cooperating assembly 104, the first protrusion 1a31 enters the first open groove 1a42, that is, the first protrusion 1a31 reaches between the first mounting body front portion 1a43 and the first mounting body rear portion 1a44. The top end of the first mounting body front portion 1a43 and the top end of the first mounting body rear portion 1a44 are not flush, which is conducive to installing the first protrusion 1a31 into the first open groove 1a42 from different directions. The second mounting guide rail and the first mounting guide rail are spaced apart and symmetrically arranged in the left-right direction and have substantially the same structure, that is, the second mounting portion is a second open groove 1b42 formed in the up-down direction with an upward opening. The second protrusion 1b31 can enter the second open groove 1b42. The other similarities will not be repeated.

The cooperating assembly 104 further includes a housing mounting portion. The housing mounting portion includes a third mounting portion and a fourth mounting portion oppositely arranged in the left-right direction. The third mounting portion and the fourth mounting portion are respectively a first through-hole (not shown) provided on the first housing 11a and a second through-hole 1e41 provided on the second housing 11b. The first protrusion 1a31 can be inserted into the first through-hole, and the second protrusion 1b31 can be inserted into the second through-hole 1e41. The third mounting portion and the fourth mounting portion may also be configured as cooperating grooves, as long as the first protrusion 1a31 can enter the third mounting portion and the second protrusion 1b31 can enter the fourth mounting portion.

In this embodiment, the housing 11 and the paper compartment 30 cooperate with the connecting assembly 103 at the same time, which can make the cooperation between the top cover assembly 20 and the main assembly 10 more stable. At the same time, the design of the mounting guide rail is convenient for the protrusion to enter. One can first make the protrusion enter the mounting guide rail, and then install the housing 11. This assembly method is easier to implement.

In other embodiments, the third mounting portion and the fourth mounting portion of the cooperating assembly 104 are configured as protrusions integrally formed with the housing. One of the first mounting portion and the second mounting portion of the cooperating assembly 104 is configured as an opening or an open groove, and the other is also configured as an opening or an open groove. The open groove is formed in the up-down direction and has an upward opening. The first connecting end and the second connecting end of the connecting assembly 103 are configured as a through-hole or a cooperating groove. The protrusion can pass through the first mounting portion or the second mounting portion and enter the through-hole or the cooperating groove, thereby connecting the connecting assembly 103 with the cooperating assembly 104. Alternatively, one of the third mounting portion and the fourth mounting portion of the cooperating assembly 104 is configured as a through-hole or a cooperating groove, and the other is configured as a protrusion. One of the first mounting portion and the second mounting portion of the cooperating assembly 104 is configured as an opening or an open groove, and the other is also configured as an opening or an open groove. The open groove is formed in the up-down direction and has an upward opening. Correspondingly, one of the first connecting end and the second connecting end of the connecting assembly is configured as a protrusion, and the other is configured as a through-hole or a cooperating groove. The protrusion can pass through the first mounting portion or the second mounting portion and enter the through-hole or cooperating groove, thereby connecting the connecting assembly 103 with the cooperating assembly 104.

### Embodiment 3

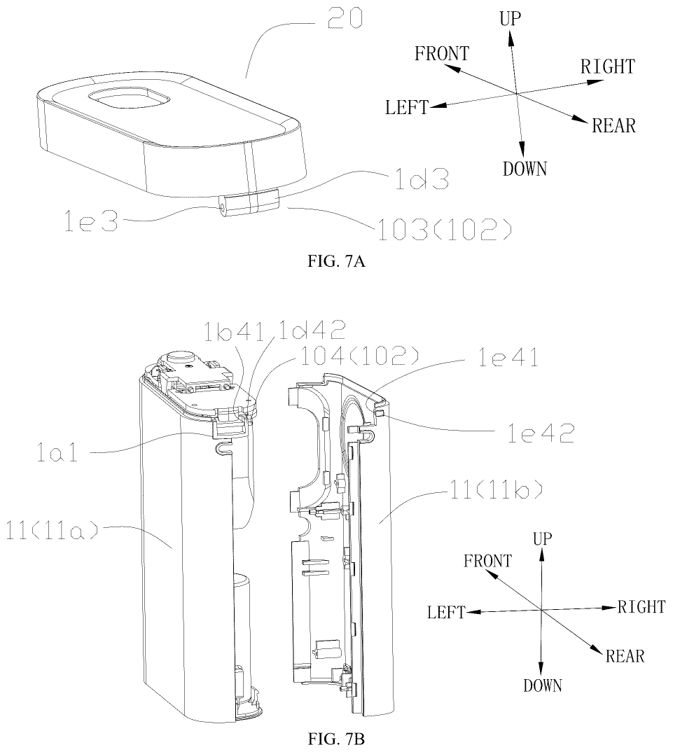

FIG. 7A is a perspective view of a top cover assembly according to Embodiment 3 of the present disclosure; FIG. 7B is an exploded view of some components of the thermal printer with the top cover assembly hidden according to Embodiment 3 of the present disclosure.

As shown in FIG. 7A and FIG. 7B, the paper compartment 30 involved in this embodiment is substantially the same as in Embodiment 1 or Embodiment 2, and will not be repeated here. The connecting assembly 103 and the housing 11 involved in this embodiment are somewhat different from those in Embodiment 1 and Embodiment 2, and the differences will be described in this embodiment.

In this embodiment, the connecting assembly 103 includes a connecting assembly body 1d3 and a penetrating hole 1e3 provided on the connecting assembly body 1d3. The connecting assembly body 1d3 extends downward from the bottom wall of the top cover assembly 20. In the left-right direction, the penetrating hole 1e3 penetrates the connecting assembly body 1d3.

The cooperating assembly 104 also includes a housing mounting portion. The housing mounting portion includes a third mounting portion and a fourth mounting portion oppositely arranged in the left-right direction. The third mounting portion is a positioning post 1d42 provided on the first housing 11a. The positioning post 1d42 extends rightward in the left-right direction and is integrally formed with the housing 11a. The positioning post 1d42 can extend into the penetrating hole 1e3 and extend out from the right side of the penetrating hole 1e3. The fourth mounting portion is a second through-hole 1e41 provided on the second housing 11b. At least a part of the positioning post 1d42 that extends out from the penetrating hole 1e3 can extend into the second through-hole 1e41. In addition, the fourth mounting portion may also be configured as a cooperating groove, as long as at least a part of the positioning post can enter the fourth mounting portion.

The housing 11 at the location of the second through-hole 1e41 may also be provided with a protection portion 1e42. The protection portion 1e42 extends from the housing 11 toward the rear side of the thermal printer 100. The protection portion 1e42 is configured to protect the second through-hole 1e41.

In other embodiments, the fourth mounting portion is a positioning post provided on the second housing. The positioning post can extend into the penetrating hole 1e3 and extend out from the left side of the penetrating hole 1e3. The third mounting portion is a first through-hole provided on the first housing. At least a part of the positioning post that extends out from the penetrating hole 1e3 can extend into the first through-hole. The third mounting portion may also be configured as a cooperating groove, as long as at least a part of the positioning post can enter the third mounting portion. The housing 11 at the location of the first through-hole may also be provided with a protection portion. The protection portion extends from the housing 11 toward the rear side of the thermal printer 100. The protection portion is configured to protect the first through-hole.

The positioning post involved in this embodiment can not only connect the top cover assembly 20 and the main assembly 10, but also serve as a positioning function during the assembly of the first housing 11a and the second housing 11b. At the same time, the housing 11 and the paper compartment 30 cooperate with the connecting assembly 103 at the same time, which can make the cooperation between the top cover assembly 20 and the main assembly 10 more stable. The positioning post being integrally formed with the housing is beneficial for reducing the number of parts of the top cover assembly 20, preventing the connection between the top cover assembly 20 and the main assembly 10 from being unstable due to engagement clearance between parts, and is also beneficial for reducing assembly steps to improve assembly efficiency.

In other embodiments, the design of the cooperating assembly 104 in Embodiment 1, Embodiment 2, or Embodiment 3 may also be entirely provided on the housing 11 and integrally formed with the housing 11. That is, the design of the cooperating assembly 104 in this embodiment does not involve the paper compartment 30. This design can simplify the design of the connecting portion to simplify the structure of the thermal printer, thereby improving processing efficiency and also reducing assembly steps.

As described above, the thermal printer provided by the first set of embodiments of the present disclosure includes a top cover assembly and a main assembly coupled to each other. The main assembly includes a housing and a paper compartment for holding an imaging medium. The top cover assembly and the main assembly are coupled via a connecting portion. The connecting portion includes a connecting assembly and a cooperating assembly. The connecting assembly is integrally formed with the top cover assembly, and the cooperating assembly is integrally formed with at least one of the housing and the paper compartment. This can reduce the number of parts of the thermal printer, prevent the connection between the top cover assembly and the main assembly from being unstable due to engagement clearance between parts, and is also beneficial for reducing assembly steps to improve assembly efficiency.

### Second Set of Embodiments (Embodiment 4-Embodiment 6 and Variations Thereof)

A second set of embodiments of the present disclosure discloses a thermal printer as a label printer, comprising a main body portion 10 (i.e., main assembly) and an openable and closable cover assembly 20 (i.e., top cover assembly). The cover assembly 20 is configured to be rotatable about a rotation axis M. Among them, one of the cover assembly 20 and the main body portion 10 is provided with a connection seat 21a, and the connection seat 21a is respectively provided with a pin 22 on opposite sides in the direction of the rotation axis M. The other of the cover assembly 20 and the main body portion 10 is provided with a recessed portion 110 for receiving the connection seat 21a. Two opposite side walls 111 of the recessed portion 110 in the direction of the rotation axis M are both provided with a guide groove 112 and a connection hole 113. The guide groove 112 is configured to guide the pin 22 into the connection hole 113, and the pin 22 is rotatably engaged with the connection hole 113.

Further, the connection hole 113 is spaced apart from the guide groove 112, and the guide groove 112 has a pin export end close to the connection hole 113.

Further, the pin export end and/or a distal end of the pin 22 is provided with a guide surface inclined with respect to the rotation axis M, so that the pin 22 can exit from the guide groove 112.

Optionally, the pin 22 and the connection seat 21a are fixedly connected or have an integrally formed structure.

Optionally, the pin 22 is configured to be movable relative to the connection seat 21a along the rotation axis M. An elastic member 31 connected to the pin 22 is provided in the connection seat 21a, so that the pin 22 can extend and retract along the rotation axis M.

Further, the connection seat 21a is provided at one end of the cover assembly 20. A side of the cover assembly 20 facing the main body portion 10 is provided with a cover base plate 23. The connection seat 21a is fixedly connected to the cover base plate 23 or has an integrally formed structure therewith.

Further, the connection seat 21a is provided at one end of the cover assembly 20. A side of the cover assembly 20 facing the main body portion 10 is provided with a cover base plate 23. The connection seat 21a is provided with a mounting portion 211, and the mounting portion 211 and the cover base plate 23 form a snap-fit engagement. The pin 22 and the mounting portion 211 form a shaft-hole engagement. The elastic member 31 is provided in a receiving groove of the mounting portion 211.

Further, a surface of the pin 22 is provided with a limiting protrusion 221. The limiting protrusion 221 is provided in the connection seat 21a to prevent the pin 22 from detaching from the connection seat 21a.

Further, the elastic member 31 is a spring.

Optionally, the pin 22 comprises an elastic portion made of an elastic material, so that the pin 22 can extend and retract along the rotation axis.

In the label printer disclosed in the second set of embodiments, the connection seat 21a of the cover assembly 20 is provided with pins 22 on opposite sides. The main body portion 10 is correspondingly provided with a connection hole 113 and a guide groove 112 for guiding the pin 22 into the connection hole 113. When installing the cover assembly 20, it is only necessary to align the pin 22 with the guide groove 112 and press the cover assembly 20, so that the pin 22 can enter the connection hole 113, thereby rotationally connecting the cover assembly 20 to the main body portion 10. This has the advantages of a simple installation structure and reliable connection for the cover assembly 20.

Hereinafter, the structure of the thermal printer of the second set of embodiments will be specifically described with reference to the accompanying drawings.

### Embodiment 4

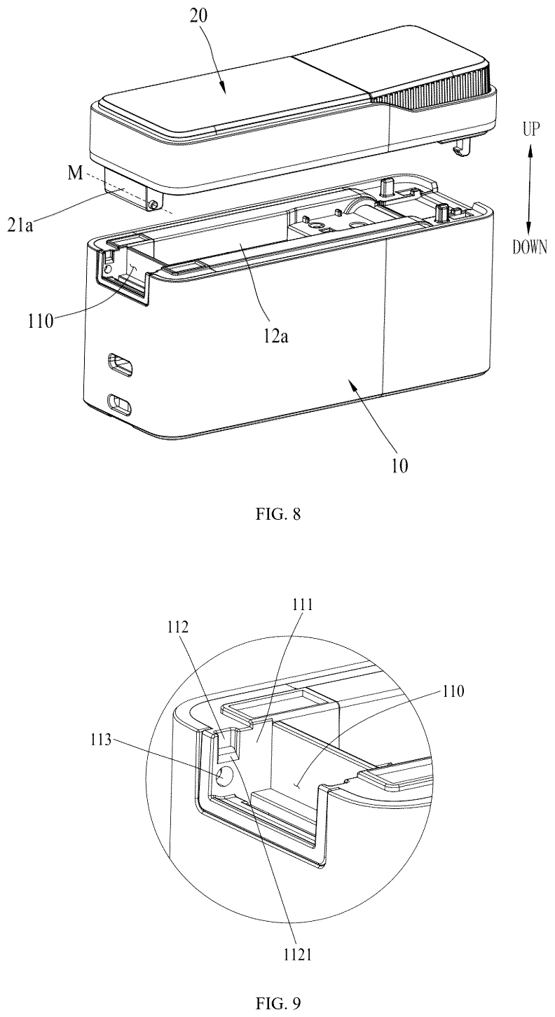

Embodiment 4 discloses a thermal printer as a label printer. As shown in FIG. 8 to FIG. 11, the label printer of Embodiment 4 includes a main body portion 10 (i.e., main assembly) and an openable and closable cover assembly 20 (i.e., top cover assembly). The main body portion 10 is provided with a paper compartment 12a for receiving a label paper roll. The cover assembly 20 is provided with a cover base plate 23 and a print head 24. The cover base plate 23 is configured to face the main body portion 10, and the print head 24 is exposed from the cover base plate 23 for printing on the label paper. As a variation of the embodiment, the print head 24 may also be provided on the main body portion 10.

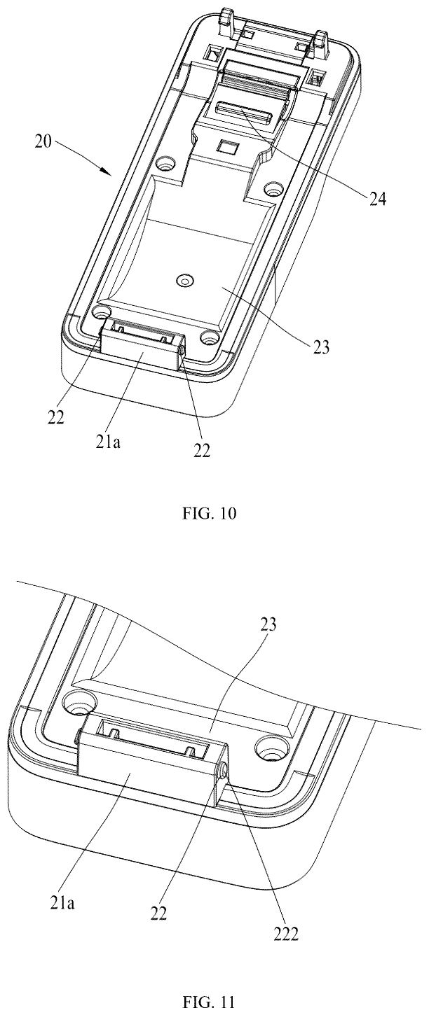

The cover assembly 20 can be rotated relative to the main body portion 10 about a rotation axis M to move between an open position and a closed position. Specifically, as shown in FIG. 10 and FIG. 11, one end of the cover assembly 20 is provided with a connection seat 21a, and the connection seat 21a is respectively provided with a pin 22 on opposite sides in the direction of the rotation axis M. In Embodiment 4, the pin 22 and the connection seat 21a may be fixedly connected (e.g., snap-fit connection) or have an integrally formed structure. Preferably, the connection seat 21a, the pin 22, and the cover base plate 23 have an integrally formed structure. The connection seat 21a with the pin 22 is used as a connecting assembly of the cover assembly 20 (top cover assembly).

As shown in FIG. 8 and FIG. 9, the main body portion 10 is provided with a recessed portion 110 for receiving the connection seat 21a. Two opposite side walls 111 of the recessed portion 110 in the direction of the rotation axis M are both provided with a guide groove 112 and a connection hole 113. The guide groove 112 is configured to guide the pin 22 into the connection hole 113, and the pin 22 is rotatably engaged with the connection hole 113. The guide groove 112 is preferably configured to extend along the up-down direction. Its upper end is a pin entry end extending to the upper surface of the main body portion 10, and its lower end is a pin export end. The connection hole 113 may be spaced apart from the guide groove 112, and the pin export end of the guide groove 112 is configured to be close to the connection hole 113. The recessed portion 110 with the guide groove 112 and the connection hole 113 is used as a cooperating assembly of the main body portion 10 (main assembly).

Preferably, the pin export end may be provided with a first guide surface 1121 inclined with respect to the rotation axis M. The first guide surface 1121 may be a curved surface, an inclined plane, or a combination thereof. A distal end of the pin 22 may be provided with a second guide surface 222. The second guide surface 222 may also be a curved surface, an inclined plane, or a combination thereof. The purpose of providing the first guide surface 1121 and/or the second guide surface 222 is to allow the pin 22 to exit the guide groove 112 smoothly.

When installing the cover assembly 20, it is only necessary to align the pin 22 with the guide groove 112 and press the cover assembly 20, so that the pin 22 can enter the connection hole 113, thereby rotationally connecting the cover assembly 20 to the main body portion 10. This has the advantages of a simple installation structure and convenient operation for the cover assembly 20. In Embodiment 4, after the pin 22 exits the guide groove 112 and before it enters the connection hole 113, the pin 22 is in hard contact with the side wall 111 of the recessed portion 110. At this time, the opposite sides of the connection seat 21a and/or the recessed portion 110 preferably may undergo appropriate elastic deformation to allow the pin 22 to enter the connection hole 113. Preferably, the connection seat 21a may have a hollow structure to facilitate appropriate elastic deformation on its opposite sides.

### Embodiment 5

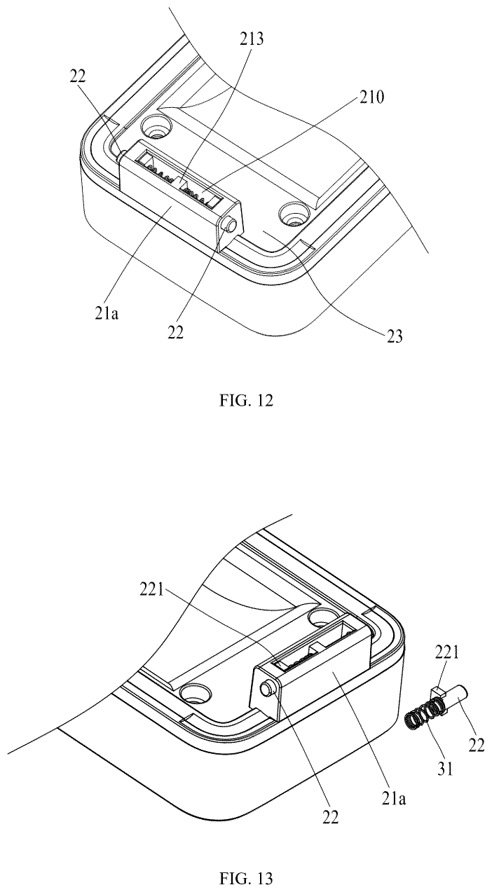

As shown in FIG. 12 and FIG. 13, in Embodiment 5, the two pins 22 located on opposite sides of the connection seat 21a are both configured to be movable relative to the connection seat 21a along the rotation axis M (see FIG. 1), for example, the pin 22 and the connection seat 21a form a sliding fit in a shaft-hole manner. An elastic member 31 connected (e.g., by abutment) to the pin 22 is provided in the connection seat 21a, so that the pin 22 can extend out from a through-hole of the connection seat 21a and can extend and retract along the rotation axis M. The elastic member 31 is preferably a spring, but may also be other elastic components such as rubber, sponge, etc., which is not limited in this application.

Specifically, in Embodiment 5, the connection seat 21a and the cover base plate 23 are an integrally formed structure, and the connection seat 21a has a cavity 210. Two elastic members 31 are provided in the cavity 210. One end of each of the two elastic members 31 is respectively connected (e.g., by abutment) with one of the two pins 22. The other end of each of the two elastic members 31 is connected (e.g., by abutment) with a partition plate 213 provided in the cavity 210. A surface of the pin 22 is provided with a limiting protrusion 221, and the limiting protrusion 221 is located in the connection seat 21a to prevent the pin 22 from detaching from the connection seat 21a.

In the initial state, the pin 22 is at the maximum extension position under the action of the elastic member 31. During the installation of the cover assembly 20, after the pin 22 exits the guide groove 112 and before it enters the connection hole 113, the pin 22 abuts against the side wall 111 of the recessed portion 110. When the pin 22 abuts against the side wall 111, the elastic member 31 is compressed, and the pin 22 can overcome the elastic force of the elastic member 31 and move toward the inside of the connection seat 21a, and then smoothly enters the connection hole 113. After the pin 22 enters the connection hole 113, the elastic force of the elastic member 31 will cause the pin 22 to move toward the outside of the connection seat 21a to ensure a reliable connection between the pin 22 and the connection hole 113.

As a variation of Embodiment 5, one elastic member may be provided between the two pins 22, and the two ends of this elastic member are respectively connected (e.g., by abutment) with the two pins 22. Other descriptions of Embodiment 5 can refer to Embodiment 4 and will not be repeated.

### Embodiment 6

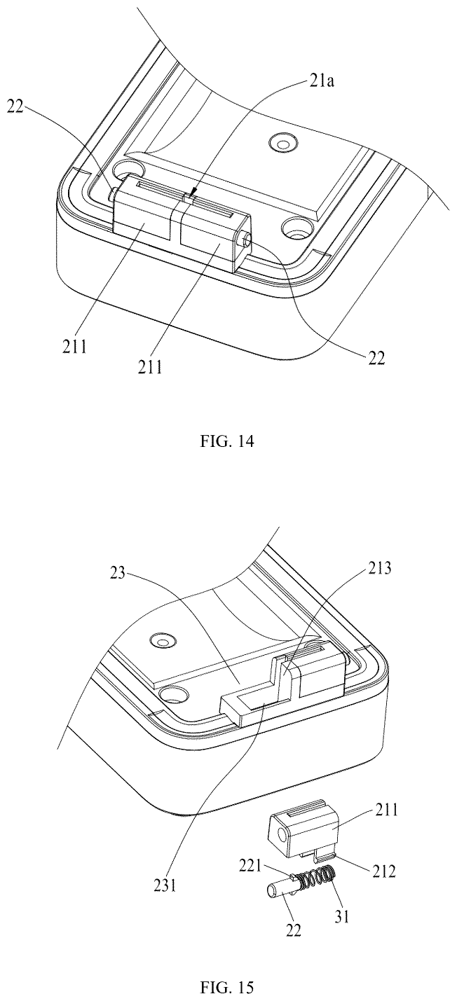

As shown in FIG. 14 and FIG. 15, in Embodiment 6, the pin 22 is also configured to be movable/retractable relative to the connection seat 21a along the rotation axis M (see FIG. 1). Different from Embodiment 5, in Embodiment 6, the connection seat 21a is a split-type structure, which has two mounting portions 211. The two pins 22 and their corresponding elastic members 31 are provided on the corresponding mounting portions 211. The pin 22 and the mounting portion 211 form a sliding fit in a shaft-hole manner. The two mounting portions 211 are respectively provided with a snap buckle 212. The cover base plate 23 is provided with a snap groove 231 that cooperates with the snap buckle 212. The snap buckle 212 may be pressed into the snap groove 231 from bottom to top, so that the mounting portion 211 and the cover base plate 23 form a snap-fit engagement and are relatively fixed in the up-down direction. The mounting portion 211 may form a hollow structure with a receiving groove, and the elastic member 31 may be provided in the receiving groove of the mounting portion 211. Specifically, one end of the elastic member 31 may abut against the pin 22, and the other end may abut against a corresponding side wall of the mounting portion 211 or a partition plate 213 located between the two connection seats 21a.

As a variation of Embodiment 6, the two pins 22 and their corresponding elastic members 31 may be provided in a same mounting portion, and this mounting portion forms a snap-fit engagement with the cover base plate 23. Other descriptions of Embodiment 6 can refer to Embodiment 4 and Embodiment 5 and will not be repeated.

In other unillustrated embodiments of the present disclosure, the pin 22 may include an elastic portion made of an elastic material (e.g., changing the elastic member 31 to form an elastic shaft as part of the pin 22), so that the pin 22 can extend and retract along the rotation axis M.

As a variation of the aforementioned embodiments, the connection seat 21a may be provided on the main body portion 10, and the recessed portion 110 may be provided on the cover assembly 20. That is, the positions of the connection seat 21a and the recessed portion 110 may be interchanged without affecting the implementation of the present disclosure.

Although the present disclosure has been described through the above embodiments, it should be understood that the above embodiments are only for illustrating the implementable solutions of the present disclosure and should not be interpreted as limiting the protection scope of the present disclosure. Any substitutions or modifications made by those skilled in the art in accordance with the present disclosure should also be covered by the protection scope of the claims of the present disclosure.

What is claimed is:

1. A thermal printer, comprising a top cover assembly and a main assembly coupled to each other,
wherein the main assembly comprises a housing and a paper compartment for holding an imaging medium, the top cover assembly and the main assembly are coupled via a connecting portion, and the connecting portion is configured to allow the top cover assembly to be flipped relative to the main assembly;
the connecting portion comprises a connecting assembly provided on the top cover assembly and a cooperating assembly provided on the main assembly; and
one of the connecting assembly and the cooperating assembly comprises a hole or a slot, and the other of the connecting assembly and the cooperating assembly comprises a protrusion, a pin, or a positioning post configured for insertion into the hole or the slot.

2. The thermal printer according to claim 1, wherein the connecting assembly is integrally formed with the top cover assembly, and the cooperating assembly is integrally formed with at least one of the housing and the paper compartment.

3. The thermal printer according to claim 1, wherein the cooperating assembly comprises a paper compartment mounting portion and an avoidance groove, the paper compartment mounting portion comprises a first mounting portion body, a second mounting portion body, a first mounting portion, and a second mounting portion, the first mounting portion and the second mounting portion are respectively provided on the first mounting portion body and the second mounting portion body and are oppositely arranged in a left-right direction, and the avoidance groove is located between the first mounting portion and the second mounting portion;
the connecting assembly comprises a first connecting body, a second connecting body, a first connecting end, a second connecting end, and a notch portion, the first connecting end and the second connecting end are respectively provided on the first connecting body and the second connecting body and are oppositely arranged in the left-right direction, and the notch portion is located between the first connecting body and the second connecting body;
one of the first connecting end and the first mounting portion is configured as an opening or a mounting groove serving as the hole or the slot, and the other of the first connecting end and the first mounting portion is configured as the protrusion; one of the second connecting end and the second mounting portion is configured as an opening or a mounting groove serving as the hole or the slot, and the other of the second connecting end and the second mounting portion is configured as the protrusion, wherein the protrusion enters the opening or the mounting groove.

4. The thermal printer according to claim 1, wherein the connecting assembly is connected to the housing and the paper compartment.

5. The thermal printer according to claim 4, wherein the cooperating assembly comprises a paper compartment mounting portion and a housing mounting portion, the paper compartment mounting portion comprises a first mounting portion and a second mounting portion oppositely arranged in a left-right direction, and the housing mounting portion comprises a third mounting portion and a fourth mounting portion oppositely arranged in the left-right direction;
the connecting assembly comprises a first connecting end and a second connecting end, the first connecting end and the second connecting end are oppositely arranged in the left-right direction; and
the first connecting end cooperates with the first mounting portion and the third mounting portion, and the second connecting end cooperates with the second mounting portion and the fourth mounting portion.

6. The thermal printer according to claim 5, wherein the first mounting portion and the second mounting portion are configured as an opening or an open groove, the open groove is formed in an up-down direction and has an upward opening;
one of the third mounting portion and the first connecting end is configured as the protrusion, and the other of the third mounting portion and the first connecting end is configured as the hole or the slot;
one of the fourth mounting portion and the second connecting end is configured as the protrusion, and the other of the fourth mounting portion and the second connecting end is configured as the hole or the slot; and
the protrusion passes through the first mounting portion or the second mounting portion and enters the hole or the slot.

7. The thermal printer according to claim 5, wherein the housing comprises a first housing and a second housing coupled to each other in the left-right direction, the third mounting portion is provided on the first housing, and the fourth mounting portion is provided on the second housing.

8. The thermal printer according to claim 4, wherein the connecting assembly comprises a connecting assembly body, a penetrating hole serving as the hole is provided on the connecting assembly body, the penetrating hole penetrates the connecting assembly body in the left-right direction, the cooperating assembly comprises a paper compartment mounting portion, and the paper compartment mounting portion comprises a first mounting portion and a second mounting portion, the first mounting portion and the second mounting portion are oppositely arranged in the left-right direction.

9. The thermal printer according to claim 8, wherein the cooperating assembly further comprises a housing mounting portion, the housing mounting portion comprises a third mounting portion and a fourth mounting portion oppositely arranged in the left-right direction, one of the third mounting portion and the fourth mounting portion is configured as the positioning post, and the other of the third mounting portion and the fourth mounting portion is configured as another hole or slot, the positioning post passes through the first mounting portion, the penetrating hole, and the second mounting portion and enters the other hole or slot.

10. The thermal printer according to claim 9, wherein the first mounting portion and the second mounting portion are configured as an opening or an open groove, the open groove is formed in an up-down direction and has an upward opening.

11. The thermal printer according to claim 9, wherein the paper compartment comprises a side wall provided on the same side as the connecting portion, and the paper compartment mounting portion is provided on the side wall; and
the housing comprises a first housing and a second housing coupled to each other in the left-right direction, the third mounting portion is provided on the first housing, the fourth mounting portion is provided on the second housing, and the penetrating hole is configured to cooperate with the third mounting portion or the fourth mounting portion.

12. The thermal printer according to claim 8, wherein an avoidance groove is formed between the first mounting portion and the second mounting portion, and the connecting assembly body is disposed in the avoidance groove.

13. The thermal printer according to claim 9, wherein when the third mounting portion or the fourth mounting portion is configured as another hole or slot, the housing at a location of the third mounting portion or the fourth mounting portion is provided with a protection portion, and the protection portion extends from the housing toward a rear side of the thermal printer.

14. The thermal printer according to claim 1, wherein one of the connecting assembly and the cooperating assembly is provided with a connection seat, the connection seat is respectively provided with the pin on opposite sides in a direction of a rotation axis of the top cover assembly;
the other of the connecting assembly and the cooperating assembly is provided with a recessed portion for receiving the connection seat, two opposite side walls of the recessed portion in the direction of the rotation axis are both provided with a connection hole serving as the hole or the slot, the pin is rotatably engaged with the connection hole, two opposite side walls of the recessed portion in the direction of the rotation axis are both provided with a guide groove, the guide groove is configured to guide the pin into the connection hole; and
the connection hole is spaced apart from the guide groove, and the guide groove has a pin export end close to the connection hole.

15. The thermal printer according to claim 14, wherein the pin export end and/or a distal end of the pin is provided with a guide surface inclined with respect to the rotation axis, thereby permitting the pin to exit from the guide groove.

16. The thermal printer according to claim 14, wherein the pin is configured to be movable relative to the connection seat along the rotation axis.

17. The thermal printer according to claim 14, wherein the connection seat is provided at one end of the top cover assembly, a side of the top cover assembly facing the main assembly is provided with a cover base plate, and the connection seat is fixedly connected to the cover base plate or has an integrally formed structure with the cover base plate.

18. The thermal printer according to claim 16, wherein an elastic member connected to the pin is provided in the connection seat, thereby permitting the pin to extend and retract along the rotation axis; or, the pin comprises an elastic portion made of an elastic material, thereby permitting the pin to extend and retract along the rotation axis; and
a surface of the pin is provided with a limiting protrusion, the limiting protrusion is provided in the connection seat to prevent the pin from detaching from the connection seat.

19. The thermal printer according to claim 1, wherein the connecting assembly comprises an avoidance groove and a top cover connecting portion, the top cover connecting portion comprises a first connecting body, a second connecting body, a first connecting portion, and a second connecting portion, the first connecting portion and the second connecting portion are respectively provided on the first connecting body and the second connecting body and are oppositely arranged in a left-right direction, and the avoidance groove is located between the first connecting portion and the second connecting portion; and
the cooperating assembly comprises a first mounting portion body, a second mounting portion body, a first mounting end, a second mounting end, and a protrusion portion, the first mounting end and the second mounting end are respectively provided on the first mounting portion body and the second mounting portion body and are oppositely arranged in the left-right direction, and the protrusion portion is located between the first mounting portion body and the second mounting portion body.

20. The thermal printer according to claim 19, wherein one of the first connecting portion and the first mounting end is configured as an opening or a mounting groove serving as the hole or the slot, and the other of the first connecting portion and the first mounting end is configured as the protrusion; one of the second connecting portion and the second mounting end is configured as an opening or a mounting groove serving as the hole or the slot, and the other of the second connecting portion and the second mounting end is configured as the protrusion, wherein the protrusion enters the opening or the mounting groove.
